(19) United States
(12) Patent Application Publication
(10) Pub. No.: US 2026/0355910 A1
(43) Pub. Date: Nov. 12, 2026

(54) ANTI-SLIP SOCKET

(71) Applicant: RE-DAI PRECISION TOOLS CO.,LTD., Taichung (TW)

(72) Inventor: Chen-Han LEE, Taichung City (TW)

(21) Appl. No.: 19/441,662

(22) Filed: Jan. 6, 2026

(30) Foreign Application Priority Data
May 8, 2025 (TW) 114117284

(51) Int. Cl. B25B 13/06

(52) U.S. Cl. CPC B25B 13/065

(57) ABSTRACT

An anti-slip socket includes a body defining a driving end, a driven end, and a central axis. A driving hole is formed in the body and extends along a driving axis that intersects the central axis to form an included angle between 1 degree and 15 degrees. The driving hole is open at the driving end and has an inner diameter that gradually decreases toward the driven end. The driving hole further includes a plurality of driving surfaces, and a plurality of anti-slip units is respectively disposed on the driving surfaces to enhance engagement with fasteners.

### BACKGROUND OF THE INVENTION

The present invention relates to a socket, and more particularly to an anti-slip socket capable of enhancing engagement with fasteners of different sizes.

Conventional sockets typically include a socket hole for receiving a fastener such as a bolt or nut. The contact surfaces of the socket hole engage the end edges of the fastener so that the fastener may be tightened or loosened. However, the inner diameter of the socket hole is generally slightly larger than the outer diameter of the fastener. As a result, only part of the contact surface actually contacts the end edges of the fastener during use, potentially causing deformation or damage to the fastener. This reduces the engagement effectiveness and may prevent the socket from properly turning the fastener. In addition, conventional sockets usually correspond to a single size of fastener and therefore cannot accommodate a wide range of fastener dimensions. This limits their usability in various assembly and disassembly applications.

### SUMMARY OF THE INVENTION

An objective of the present invention is to provide an anti-slip socket including a body and a plurality of anti-slip units. The body defines a driving end, a driven end, and a central axis extending through the driving end and the driven end. The body is provided with a driving hole extending along a driving axis that intersects the central axis to form an included angle between 1 degree and 15 degrees. The driving hole is open at the driving end and has an inner diameter that gradually decreases from the driving end toward the driven end. The driving hole includes a plurality of driving surfaces. The plurality of anti-slip units are respectively disposed on the plurality of driving surfaces.

In an embodiment, the included angle is between 6 degrees and 10 degrees.

In an embodiment, the driving hole has a half cone angle greater than 30 degrees.

Further, the half cone angle is between 50 degrees and 70 degrees.

In an embodiment, each of the plurality of anti-slip units includes a plurality of engaging grooves.

Further, the plurality of engaging grooves of each anti-slip unit extend obliquely around the driving axis and are arranged sequentially along the driving axis.

Furthermore, the plurality of engaging grooves collectively form a left-handed internal thread structure, and the plurality of engaging grooves of each anti-slip unit have an equal groove depth.

In an embodiment, The body further includes a driven hole open at the driven end.

In an embodiment, the driving hole further includes a plurality of spacing grooves respectively disposed between each two adjacent driving surfaces, wherein each of the plurality of spacing grooves extends from the driving end toward the driven end without passing through the driving axis, wherein each of the plurality of spacing grooves is in communication with the engaging grooves of the corresponding anti-slip unit. The number of the plurality of spacing grooves is six. The six spacing grooves are angularly spaced apart by 60 degrees around the driving axis.

The present invention will become clearer in light of the following detailed description of illustrative embodiments of this invention described in connection with the drawings.

### BRIEF DESCRIPTION OF DRAWINGS

FIG. 1 is a perspective view of an anti-slip socket according to the present invention.

FIG. 2 is a top plan view of the anti-slip socket of FIG. 1.

FIG. 3 is a cross-sectional view taken along line 3-3 of FIG. 2.

FIG. 4 is a cross-sectional view taken along line 4-4 of FIG. 2.

### DETAILED DESCRIPTION OF THE INVENTION

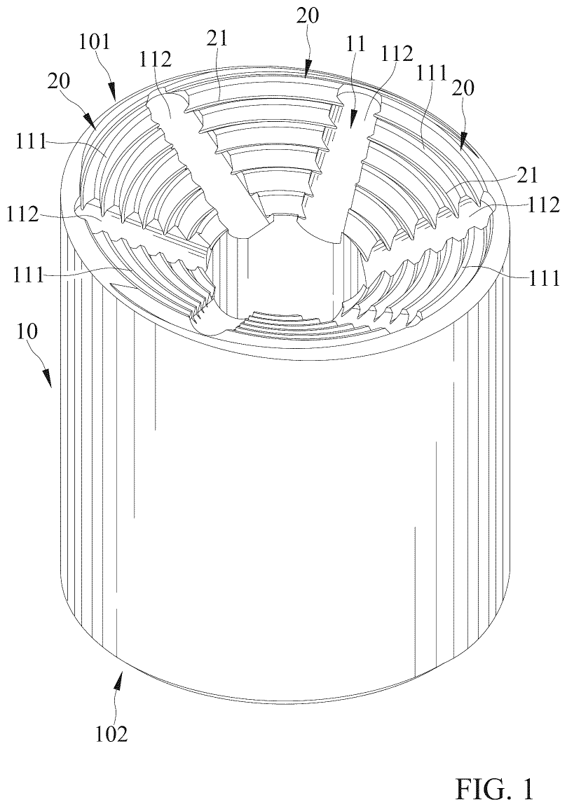

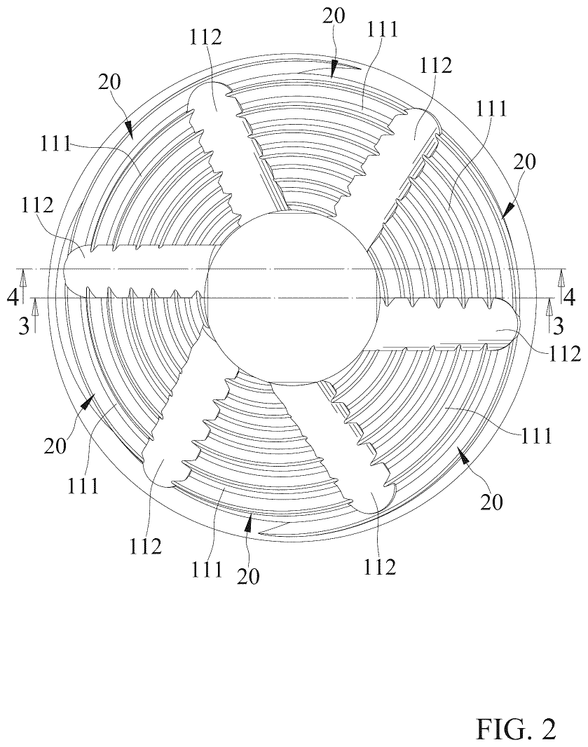

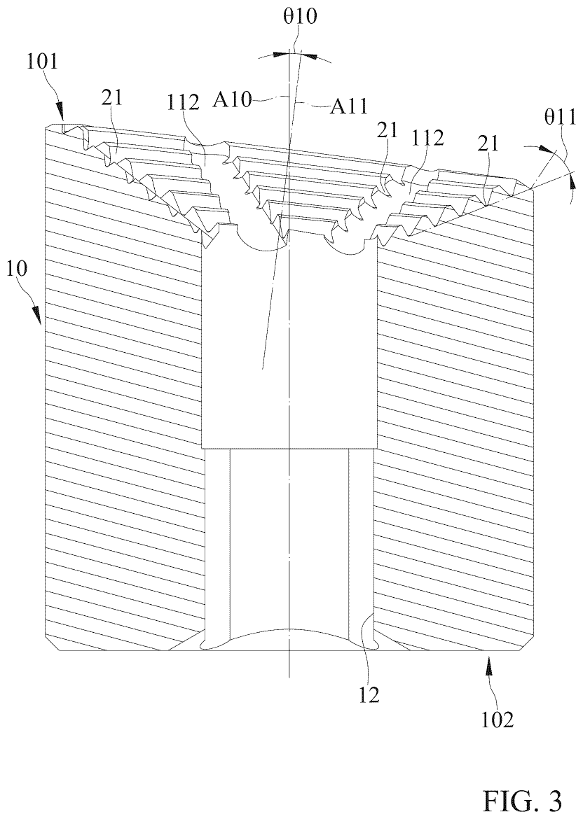

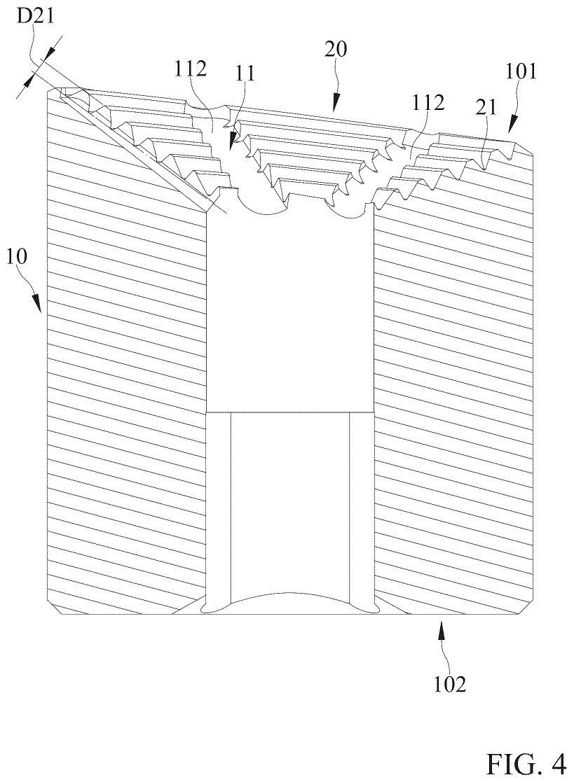

Referring to FIGS. 1 to 4, which respectively illustrate a perspective view, a top plan view, and cross-sectional structural views of an anti-slip socket according to the present invention, the anti-slip socket includes a body 10 and a plurality of anti-slip units 20.

The body 10 defines a driving end 101, a driven end 102, and a central axis A10 extending through the driving end 101 and the driven end 102. The body 10 is provided with a driving hole 11 that extends along a driving axis A11. The driving axis A11 intersects the central axis A10 to form an included angle θ10 between 1 degree and 15 degrees. Preferably, in this embodiment, the included angle θ10 is between 6 degrees and 10 degrees. The driving hole 11 is open at the driving end 101 to receive a fastener such as a bolt or nut (not shown), and the inner diameter of the driving hole 11 gradually decreases from the driving end 101 toward the driven end 102, thereby forming a tapered hole. A plurality of driving surfaces 111 adapted to contact the fastener is disposed inside the driving hole 11, and the driving surfaces 111 may be planar or curved. The body 10 may further include a driven hole 12 open at the driven end 102 for engagement with a driving tool (not shown).

In addition, the driving hole 11 may be provided with a plurality of spacing grooves 112. The spacing grooves 112 are respectively located between each two adjacent driving surfaces 111, and the extending direction of each spacing groove 112 does not pass through the driving axis A11. Each spacing groove 112 extends from the driving end 101 toward the driven end 102. In this embodiment, the number of spacing grooves 112 is six, and accordingly, the numbers of the driving surfaces 111 and the anti-slip units 20 are also six. The six spacing grooves 112 are angularly spaced apart by 60 degrees around the driving axis A11. Thus, the driving hole 11 may be formed in a hexagonal, octagonal, or dodecagonal shape depending on design requirements.

The plurality of anti-slip units 20 is respectively disposed on the plurality of driving surfaces 111 to enhance the engagement between the driving hole 11 and the fastener, thereby achieving an anti-slip effect.

Furthermore, the driving hole 11 may have a half cone angle θ11 greater than 30 degrees. Preferably, in this embodiment, the half cone angle θ11 is between 50 degrees and 70 degrees.

To provide biting engagement with the fastener, each of the anti-slip units 20 includes a plurality of engaging grooves 21. The engaging grooves 21 extend obliquely around the driving axis A11 and are arranged sequentially along the driving axis A11. As a result, the engaging grooves 21 collectively form a left-handed internal thread structure, which may be a sawtooth thread configuration.

In this embodiment, the engaging grooves 21 each have an equal groove depth D21. Specifically, the groove depth D21 refers to the recessed distance of each engaging groove 21 formed on the corresponding driving surface 111, and it will be appreciated that the groove depth D21 may be adjusted according to design requirements.

In summary, in the anti-slip socket of the present invention, the tapered configuration of the driving hole 11 enables engagement with fasteners of various sizes. The greater the half cone angle θ11, the greater the range of fastener sizes that can be driven. Larger fasteners may be received near the driving end 101, while smaller fasteners may be received farther away from the driving end 101. Thus, fasteners of different sizes can contact the anti-slip units 20, and the engaging grooves 21 of the anti-slip units 20 can bite into the outer edges of the fasteners, thereby enhancing anti-slip performance and allowing the fasteners to be effectively turned.

Although specific embodiments have been illustrated and described, numerous modifications and variations are still possible without departing from the scope of the invention. The scope of the invention is limited by the accompanying claims.

1. An anti-slip socket comprising:
a body defining a driving end, a driven end, and a central axis extending through the driving end and the driven end, wherein the body is provided with a driving hole extending along a driving axis that intersects the central axis to form an included angle between 1 degree and 15 degrees, wherein the driving hole is open at the driving end and has an inner diameter that gradually decreases from the driving end toward the driven end, and wherein the driving hole includes a plurality of driving surfaces; and
a plurality of anti-slip units respectively disposed on the plurality of driving surfaces.

2. The anti-slip socket of claim 1, wherein the included angle is between 6 degrees and 10 degrees.

3. The anti-slip socket of claim 1, wherein the driving hole has a half cone angle greater than 30 degrees.

4. The anti-slip socket of claim 3, wherein the half cone angle is between 50 degrees and 70 degrees.

5. The anti-slip socket of claim 4, wherein each of the plurality of anti-slip units includes a plurality of engaging grooves.

6. The anti-slip socket of claim 5, wherein the plurality of engaging grooves of each anti-slip unit extend obliquely around the driving axis and are arranged sequentially along the driving axis.

7. The anti-slip socket of claim 6, wherein the plurality of engaging grooves collectively form a left-handed internal thread structure.

8. The anti-slip socket of claim 5, wherein the plurality of engaging grooves of each anti-slip unit have an equal groove depth.

9. The anti-slip socket of claim 1, wherein the body further includes a driven hole open at the driven end.

10. The anti-slip socket of claim 6, wherein the driving hole further includes a plurality of spacing grooves respectively disposed between each two adjacent driving surfaces, wherein each of the plurality of spacing grooves extends from the driving end toward the driven end without passing through the driving axis, wherein each of the plurality of spacing grooves is in communication with the engaging grooves of the corresponding anti-slip unit, wherein the number of the plurality of spacing grooves is six, and wherein the six spacing grooves are angularly spaced apart by 60 degrees around the driving axis.
